(19) United States
(12) Patent Application Publication
(10) Pub. No.: US 2009/0250453 A1
(43) Pub. Date: Oct. 8, 2009

(54) Electric conduction heating device

(75) Inventors: Tamio Okada, Tokyo (JP); Hideaki Ohashi, Osaka (JP); Yuzo Shimada, Osaka (JP); Shinji Origuchi, Osaka (JP)

Correspondence Address: POSZ LAW GROUP, PLC, 12040 SOUTH LAKES DRIVE, SUITE 101, RESTON, VA, 20191, US

(73) Assignee: NIPPON CRUCIBLE CO., LTD., Shibuya-ku, Tokyo (JP)

(21) Appl. No.: 11/990,777

(22) PCT Filed: Sep. 1, 2005
(86) PCT No.: PCT/JP2005/016017

§ 371 Date: Feb. 21, 2008

(51) Int. Cl. F27D 11/00

(52) U.S. Cl. 219/438

(57) ABSTRACT

An electric conduction heating device having an electrically conductive container (20), an upper electrode (16) and a lower electrode (12), wherein material accommodated in the container (20) can be heated by supplying electric current to the container (20) while the upper portion and bottom portion of the container (20) are sandwiched by the upper electrode (16) and the lower electrode (12); the container (20) being provided with a lower barrel (20a) and an upper barrel (20b) whose electrical resistivity is lower than that of the lower barrel (20a).

This electric conduction heating device can efficiently heat the material accommodated therein.

### TECHNICAL FIELD

The present invention relates to an electric conduction heating device. More specifically, the present invention relates to an electric conduction heating device by which materials, such as aluminum and like metals and ceramics, are melted and held.

### BACKGROUND OF THE INVENTION

Combustion heating devices using a burner are known as equipment for melting and holding a metal material to be cast. However, the use of combustion heating devices may deteriorate the operating conditions due to exhaust gas, noise, etc. Furthermore, the direct heating of a molten metal may contaminate the metal material due to gas entrainment, oxidation, etc. Also, the use of combustion heating devices may cause local heating, therefore making it difficult to unify the material temperature.

Examples of prior art heating methods, other than the above-mentioned combustion-type heating devices, include indirect heating using an electric heater, induction heating, etc. However, indirect heating is inefficient in terms of thermal efficiency, and induction heating has problems such as gas entrainment attributable to churning, etc.

An electric conduction heating device, by which the above problems can be overcome, is known wherein a material accommodated in the container is heated by supplying electricity to the container (for example, Patent Document 1). The electric conduction heating device disclosed in Patent Document 1 comprises, as shown in FIG. 3, an upper electrode 51, a lower electrode 52, and a graphite crucible 53 held between the upper electrode 51 and the lower electrode 52.

In this electric conduction heating device, an electric current is supplied to the graphite crucible 53 by applying a voltage across the upper electrode 51 and the lower electrode 52, so that the entire graphite crucible 53 is heated, thereby allowing the accommodated material to be uniformly heated.

Patent Document 1: Japanese Unexamined Patent Publication No. 1995-167847

### SUMMARY OF THE INVENTION

### Problem to Be Solved by the Invention

However, in the above-described electric conduction heating device, the graphite crucible has to be maintained at a relatively high temperature for a long time to keep the material in a molten condition. Therefore, it is difficult to reduce power consumption with this method.

An object of the present invention is to solve the above problem and to provide an electric conduction heating device by which materials can be efficiently heated.

### Means for Solving the Problem

The object of the present invention can be achieved by an electric conduction heating device having:

an electrically conductive container;

an upper electrode; and

a lower electrode;

wherein a material accommodated in the container is heated by supplying an electric current to the container while the upper portion and bottom portion of the container are sandwiched by the upper electrode and the lower electrode;

the container having a lower barrel and an upper barrel whose electrical resistivity is lower than that of the lower barrel.

In this electric conduction heating device, it is preferable that the electrical resistivity of the lower barrel be 10×10⁻³ to 500×10⁻³ Ω·cm, and that the ratio of the electrical resistivity of the upper barrel to that of the lower barrel be 0.001 to 0.8.

The object of the present invention can also be achieved by an electric conduction heating device having:

an electrically conductive container;

an upper electrode; and

a lower electrode;

wherein a material accommodated in the container is heated by supplying an electric current to the container while the upper portion and bottom portion of the container are sandwiched by the upper electrode and the lower electrode;

the container having a lower barrel and an upper barrel that is thicker than the lower barrel.

It is preferable that the thickness of the upper barrel of the electric conduction heating device be greater than that of the lower barrel by not less than 20%.

It is also preferable that the ratio of the height of the upper barrel to the total height of the container of the electric conduction heating device be 0.05 to 0.3.

It is also preferable that the electric conduction heating device be provided with a heat insulating material between the container and the upper electrode and between the container and the lower electrode.

It is also preferable that the electric conduction heating device further be provided with a base lying between the container and the lower electrode for holding the bottom of the container, wherein the base has an electrical resistivity lower than that of the lower barrel.

### BRIEF DESCRIPTION OF THE DRAWINGS

FIG. 1 is a plan view of one embodiment of the electric conduction heating device of the present invention.

FIG. 2 is a cross-sectional view taken along the line A-A of FIG. 1.

FIG. 3 is a longitudinal sectional view of a prior art electric conduction heating device.

### EXPLANATION OF REFERENCE NUMERALS

1 electric conduction heating device
2 casing
12 lower electrode
14 base
16 upper electrode
20 container
20a lower barrel
20b upper barrel
22 conductive heat insulating material

### BEST MODE FOR CARRYING OUT THE INVENTION

Embodiments of the present invention are explained below with reference to the attached drawings.

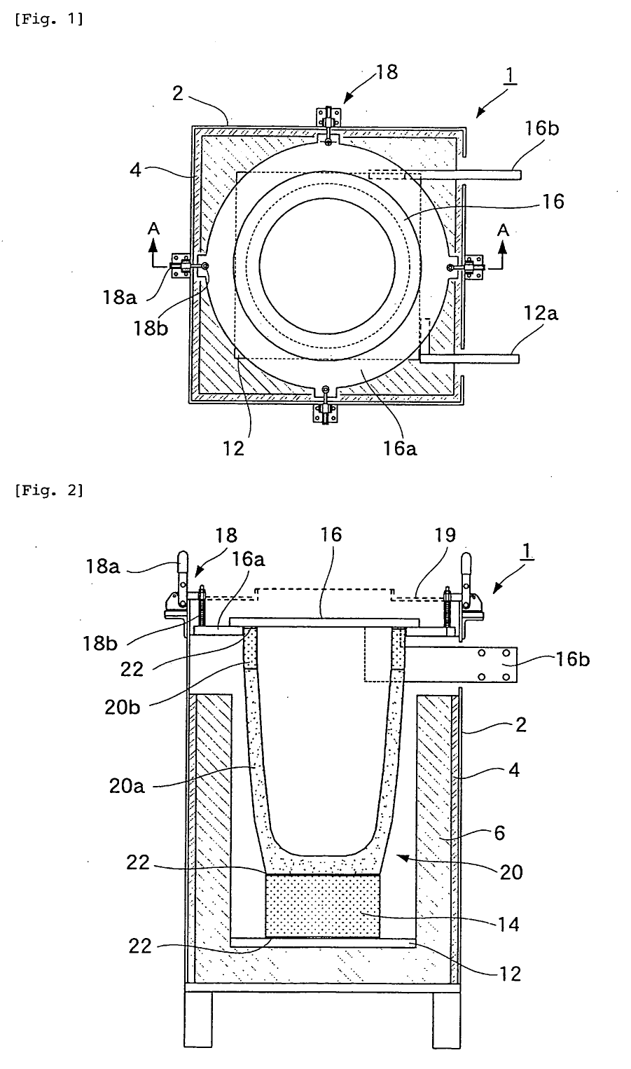

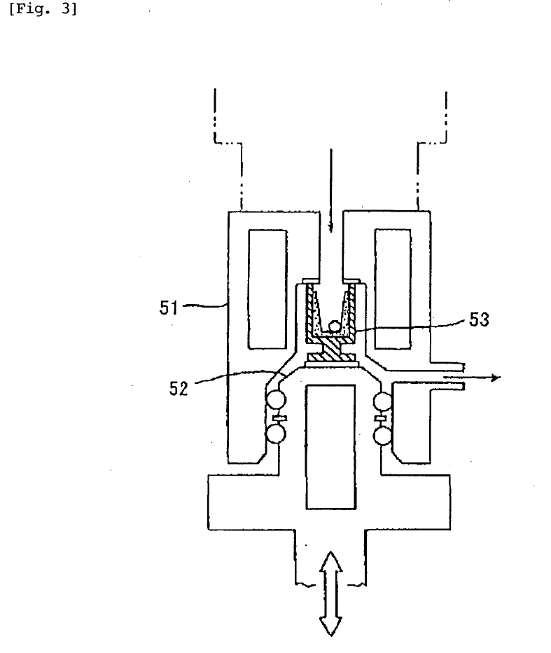

FIG. 1 is a plan view of one embodiment of the electric conduction heating device of the present invention. FIG. 2 is a cross-sectional view taken along the line A-A of FIG. 1. As shown in FIGS. 1 and 2, the electric conduction heating device 11 has a box-like casing 2 provided with a ceramic plate or like heat insulating material 4 inside thereof. On the inside surface of the heat insulating material 4, a refractory brick or like fire-resistant material 6 is provided.

A flat lower electrode 12 is horizontally provided on the bottom of the casing 2 with the fire-resistant material 6 disposed therebetween. A conductive plate 12a, which upwardly extends along the fire-resistant material 6 and protrudes from the side wall of the casing 2, is connected to the lower electrode 12. A base 14 is provided on the top surface of the lower electrode 12 and a container 20 is provided on the base 14.

The container 20 is formed of a conductive material and has a crucible shape with an opening in the top portion thereof. The barrel portion of the container 20 has a lower barrel 20a and an upper barrel 20b, which is connected to the top end of the lower barrel 20a. The lower barrel 20a, which is located between the base 14 and the upper barrel 20b, has an electrical resistivity that is greater than that of the base 14 and the upper barrel 20b. In the present embodiment, the electrical resistivity of the base 14 and the upper barrel 20b is set at 5×10⁻³ Ω·cm, and that of the lower barrel 20a is set at 100×10⁻³ Ω·cm. The thickness of the upper barrel 20b and the lower barrel 20a is about 24 mm to about 30 mm. Table 1 shows the components of the base 14, the lower barrel 20a, and the upper barrel 20b of the present embodiment, and the physical properties thereof.

TABLE 1

| | | | Conductive |
|---|---|---|---|
| | | Upper Barrel | Insulating |
| Properties | Lower Barrel | and Base | Material |
| Components | (%) | | |
| C | 30 | 35 | 73 |
| SiC | 33 | 41 | — |
| SiO₂ | 22 | 9 | — |
| Al₂O₃ | 10 | 8 | 18 |
| Apparent Porosity (%) | 19.5 | 21.0 | Unknown |
| Bulk Specific Gravity | 2.15 | 1.98 | 0.9 |
| Flexural Strength (MPa) | 13.7 | 12.3 | Unknown |
| Electrical Resistivity | 100 | 5.0 | 2 |
| (×10⁻³ Ω · cm) | | | |

It is preferable that the height of the upper barrel 20b be such that the material accommodated in the container 20 does not come into contact with the inner circumferential surface of the upper barrel 20b under normal conditions. That is, when a desirable amount of material is accommodated in the container 20, the surface of the molten material is located lower than the portion connecting the lower barrel 20a with the upper barrel 20b. More specifically, the ratio of the height of the upper barrel 20b to the total height of the container 20 is preferably 0.05 to 0.3, and more preferably 0.1 to 0.2.

The container 20 can be manufactured, for example, in the following manner. First, the amount ratio between graphite or a like low electrical resistive material and alumina or a like high electrical resistive (insulating) material is adjusted so that a desired electrical resistivity can be obtained. Second, the thus-prepared material is mixed with liquid tar pitch, resin or the like to obtain a clay. Clays having different electrical resistivities are laminated in a mold. The laminated clays are then subjected to press molding and sintered in order to obtain the necessary strength. The resulting clay is then shaped into a desired shape on a lathe, etc., if necessary, obtaining a container 20.

A ring-like upper electrode 16 that is in contact with the periphery of the opening of the container 20 is disposed on the container 20. The upper electrode 16 has an overhanging portion 16a that protrudes from the periphery of the opening on the outside edge relative to the radial direction, and a conductive plate 16b that protrudes from the side surface of the casing 2.

One clamp 18 is provided in the substantially central portion of the upper edge of each side surface of the casing 2. The clamp 18 is provided with a lever 18a and a spring 18b. The clamp 18 is structured so that one end of the spring 18b comes into contact with the top surface of the overhanging portion 16a by the rotation of the lever 18a, resulting in a compressed condition. Utilizing the energizing force of the spring 18b, the upper portion and bottom portion of the container 20 can be sandwiched by the upper electrode 16 and the lower electrode 12. As shown by the dashed line of FIG. 2, the upper portion of the casing 2 is covered by a lid 19 having an opening in the portion corresponding to that of the opening of the container 20.

A conductive heat insulating material 22 is provided between the lower electrode 12 and the base 14, between the base 14 and the container 20, and between the container 20 and the upper electrode 16. Preferable examples of the conductive heat insulating material 22 include those having excellent conductivity, heat insulation and adherence. In the present embodiment, a graphite gasket having a thickness of 3 mm is used (whose chemical and physical properties are shown in Table 1). When a graphite gasket is used, the graphite carbon content is preferably 50 to 100%. Other examples of conductive heat insulating material 22 include a woven sheet using aluminum or like metal, etc.

In the electric conduction heating device having the above-described structure, with aluminum or like material accommodated in the container 20, the conductive plates 12a and 16b are connected to a thyristor rectifier or other power supply (not shown). By applying a voltage across the lower electrode 12 and the upper electrode 16, electricity is supplied to the base 14, the lower barrel 20a and the upper barrel 20b. The accommodated material can thereby be heated and melted, and such conditions are maintained.

In the present embodiment, the container 20 is provided with the lower barrel 20a and the upper barrel 20b. Because the electrical resistivity of the upper barrel 20b is set lower than that of the lower barrel 20a, the lower barrel 20a becomes hotter than the upper barrel 20b when electricity is supplied. Therefore, the material can be satisfactorily heated in the lower barrel 20a, which is the part that has the most contact with the material, and heating can be suppressed in the upper barrel 20b, which does not have much contact with the material. By employing this structure, efficient material heating and energy reduction can be achieved. Furthermore, the container 20 of the present embodiment has excellent heatability, and satisfactory durability can be attained even without controlling the atmosphere by using Ar or like inert gas, etc.

When the container 20 is placed on the base 14 as in the present embodiment, heating in the base 14 can be suppressed by setting the electrical resistivity of the base 14 lower than that of the lower barrel 20a.

In the present embodiment, the upper barrel 20b and the base 14, both of which have lower electrical resistivity than the lower barrel 20a, are disposed on the top and bottom surfaces of the lower barrel 20a. However, the energy consumption can also be reduced as in the present embodiment by constructing the barrel of the container 20 in three layers, i.e., providing a middle layer with an upper layer and a lower layer on the top and bottom surfaces thereof, the upper layer and the lower layer having lower electrical resistivity than the middle layer.

In the container 20 of the present embodiment, if the electrical resistivity of the lower barrel 20a is too low, the reduction of energy consumption becomes difficult because the lower barrel 20a requires a high-current power supply.

Furthermore, this makes it difficult to reduce heating in the portions connecting the components to which current is supplied. If the thickness of the container 20 is made unduly thin to increase the electrical resistance, the function and durability of the container may be adversely affected. In contrast, if the electrical resistivity of the lower barrel 20a is unduly high, a high voltage becomes necessary and this often causes an electric discharge. Therefore, the electrical resistivity of the lower barrel 20a is preferably 10×10⁻³ to 500×10⁻³Ω·cm, and more preferably 50×10⁻³ to 200×10⁻³° C.

In order to obtain satisfactory energy-saving effects, the ratio of the electrical resistivity of the upper barrel 20b or the base 14 relative to the electrical resistivity of the lower barrel 20a is preferably 0.001 to 0.8, and more preferably 0.01 to 0.3. The preferable electrical resistivity of the lower barrel 20a and the upper barrel 20b can be suitably selected by, for example, changing the content ratio between a low electrical resistive material and a high electrical resistive material (insulating material) in the process for producing the container 20 described above.

In the present embodiment, a conductive heat insulating material 22 is provided between the container 20 and the upper electrode 16, between the container 20 and the base 14 and between the base 14 and the lower electrode 12. This reduces the heat loss caused by discharging the heat generated in the container 20 from the upper electrode 16 and the lower electrode 12. This allows the material to be heated efficiently.

In the present embodiment, the lower barrel 20a is made hotter than the upper barrel 20b by setting the electrical resistivity of the upper barrel 20b lower than that of the lower barrel 20a. However, instead of causing the electrical resistivity to differ between the lower barrel 20a and the upper barrel 20b, the same effects as in the present embodiment can be achieved by making the upper barrel 20b thicker than the lower barrel 20a to suppress heating in the upper barrel 20b. The connection between the lower barrel 20a and the upper barrel 20b may be in a step-like form, or the thickness in the vicinity of the connection may continuously change.

More specifically, the thickness of the upper barrel 20b is preferably larger than that of the lower barrel 20a by at least 20%. In this case, the thickness of the lower barrel 20a is, for example, 25 mm to 30 mm. There is no particular upper limit for the thickness of the upper barrel 20b, but not greater than 60 mm is preferable from the viewpoint of practical use.

### INDUSTRIAL APPLICABILITY

The electric conduction heating device of the present invention can effectively heat the material accommodated therein.

1. An electric conduction heating device comprising:
an electrically conductive container;
an upper electrode; and
a lower electrode;
wherein a material accommodated in the container is heated by supplying electric current to the container while the upper portion and bottom portion of the container are sandwiched by the upper electrode and the lower electrode;
the container comprising a lower barrel and an upper barrel whose electrical resistivity is lower than that of the lower barrel.

2. An electric conduction heating device according to claim 1, wherein the lower barrel has an electrical resistivity of 10×10⁻³ to 500×10⁻³ Ω·cm, and the ratio of the electrical resistivity of the upper barrel to the electrical resistivity of the lower barrel is 0.001 to 0.8.

3. An electric conduction heating device comprising:
an electrically conductive container;
an upper electrode; and
a lower electrode;
wherein a material accommodated in the container is heated by supplying electric current to the container while the upper portion and bottom portion of the container are sandwiched by the upper electrode and the lower electrode;
the container comprising a lower barrel and an upper barrel that is thicker than the lower barrel.

4. An electric conduction heating device according to claim 3, wherein the thickness of the upper barrel is greater than that of the lower barrel by not less than 20%.

5. An electric conduction heating device according to claim 1, wherein the ratio of the height of the upper barrel to the total height of the container is 0.05 to 0.3.

6. An electric conduction heating device according to claim 1, wherein a heat insulating material is provided between the container and the upper electrode and between the container and the lower electrode.

7. An electric conduction heating device according to claim 1, which further comprises a base lying between the container and the lower electrode for holding the bottom of the container, wherein the base has an electrical resistivity that is lower than that of the lower barrel.
